(19) United States
(12) Patent Application Publication
(10) Pub. No.: US 2019/0012595 A1
(43) Pub. Date: Jan. 10, 2019

(54) NEURAL NETWORK CONSENSUS USING BLOCKCHAIN

(71) Applicant: POINTR DATA, INC., San Jose, CA (US)

(72) Inventors: Nurettin Burcak Beser, Palo Alto, CA (US); Saran Saund, Mountain View, CA (US); Paul Lambert, Mountain View, CA (US)

(21) Appl. No.: 16/029,377

(22) Filed: Jul. 6, 2018

Related U.S. Application Data
(63) Continuation of application No. 62/529,931, filed on Jul. 7, 2017.

(51) Int. Cl. G06N 3/08; G06N 3/04

(52) U.S. Cl. CPC G06N 3/08; G06N 3/04

(57) ABSTRACT

A neural network may comprise one or more nodes and validation nodes. Each node may execute a computing model and, in response to detecting a model update event in the computing model, may generate model update data and transmit the model update data to one or more validation nodes. The validation nodes may generate an updated computing model based on the model update data. The validation nodes may validate and consent to the model update data and/or the updated computing model using blockchain technologies. The validation nodes may consent to the model update data and/or the updated computing model using a consensus algorithm or by testing the model update data and/or the updated computing model. The validation nodes may write the model update data and/or the updated computing model to a model blockchain, and broadcast the writes to the neural network.

### CROSS REFERENCE TO RELATED APPLICATIONS

This application is a nonprovisional application of and claims priority to U.S. Provisional Patent Application Ser. No. 62/529,931, filed Jul. 7, 2017, entitled “NEURAL NETWORK CONSENSUS USING BLOCKCHAIN,” which is incorporated herein by reference in its entirety.

### FIELD

This disclosure generally relates to artificial neural networks, and more particularly, to systems and methods for the consensus and updating of computing models used in artificial neural networks implementing blockchain technologies.

### BACKGROUND

Artificial neural networks may be used to perform a variety of machine learning and artificial intelligence processing. Artificial neural networks typically include a plurality of local units or nodes. Each local node may comprise a computing model configured to perform local tasks computations. Over time, each local node may detect prediction errors, generate training data, and retrain the locally-stored copy of the computing model based on the detected prediction errors. Local updates made by each local node may cause each locally-stored computing model to diverge from the initially distributed computing model.

Typically, the initially distributed computing model may be retrained by having each local node transmit local updates to a training-processing cluster or cloud configured to process and retrain the computing model. The local update data may have large file sizes and may introduce considerable latency in the artificial neural network. Moreover, retraining may not be appropriate for all local nodes, as variations in physical location or application may not be accommodated by the training-processing cluster or cloud. Updates to the computing models may also be susceptible to malicious or accidental introduction of bad training data or bad models.

### SUMMARY

Systems, methods, and computer readable mediums (collectively, the “system”) are disclosed for the consensus and updating of computing models for artificial neural networks. The neural network may comprise one or more nodes and one or more validation nodes. The nodes may each comprise a computing model. The validation node may receive model update data corresponding to the computing model. The validation node may validate the model update data by establishing consensus with at least a second validation node in the neural network. The validation node may write the model update data to a model blockchain. The validation node may generate an updated computing model based on the model update data. The validation node may broadcast the updated computing model to a first node in the neural network.

In various embodiments, the validation node may also validate the updated computing model by establishing consensus with the second validation node in the neural network and/or testing the updated computing model. The validation node may write the updated computing model to the model blockchain. The validation node may propagate the updated computing model write to the model blockchain to at least the second validation node in the neural network.

In various embodiments, the validation node may also propagate the model update data write to the model blockchain to at least the second validation node in the neural network. The model update data may comprise testing data and/or an updated model. The model update data may be generated by the first node of the neural network based on the detection of a model update event in the computing model. The model update event may comprise a prediction error, a new model requirement, or the like.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. However, a more complete understanding of the present disclosure may be obtained by referring to the detailed description and claims when considered in connection with the drawing figures, wherein like numerals denote like elements.

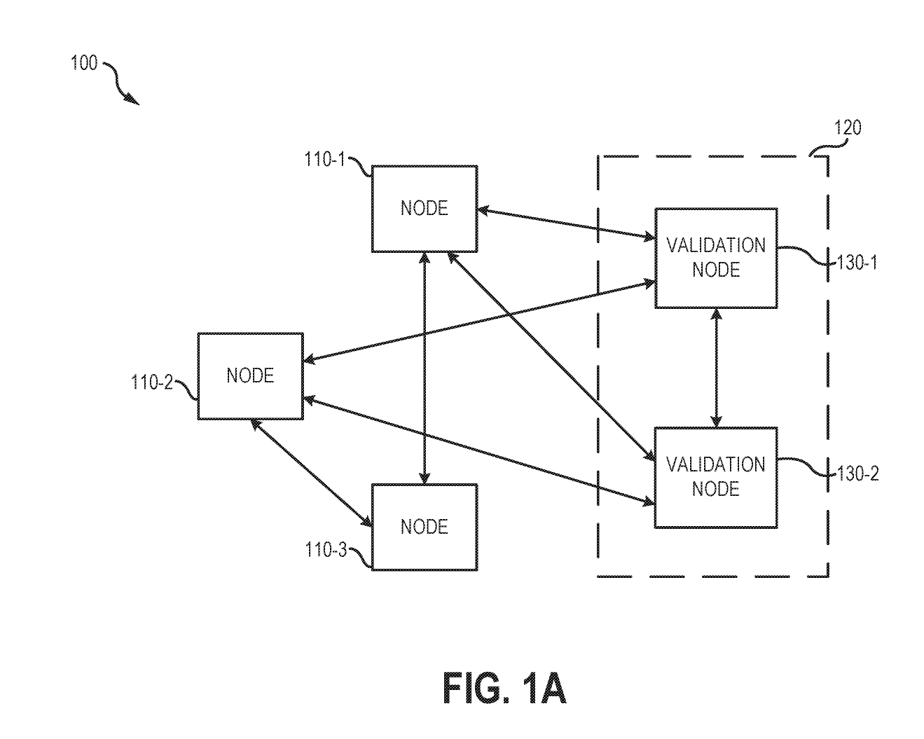

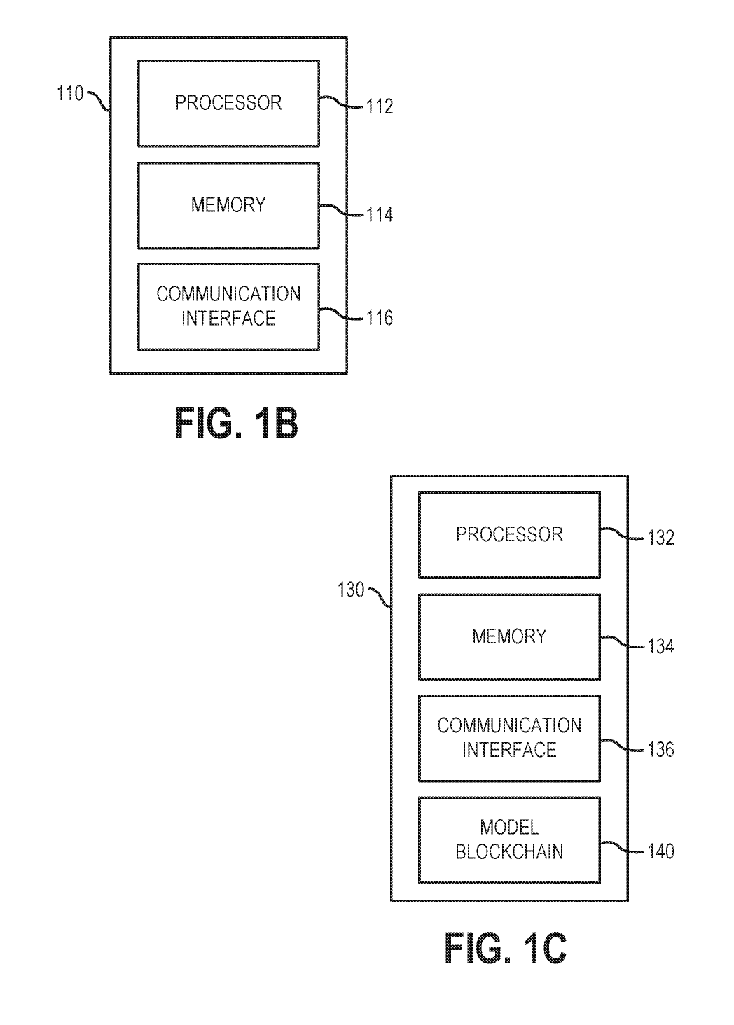

FIG. 1A is a block diagram illustrating a system for neural network consensus using blockchain, in accordance with various embodiments;

FIG. 1B is a block diagram illustrating an exemplary node for use in the system for neural network consensus using blockchain, in accordance with various embodiments;

FIG. 1C is a block diagram illustrating an exemplary validation node for use in the system for neural network consensus using blockchain, in accordance with various embodiments;

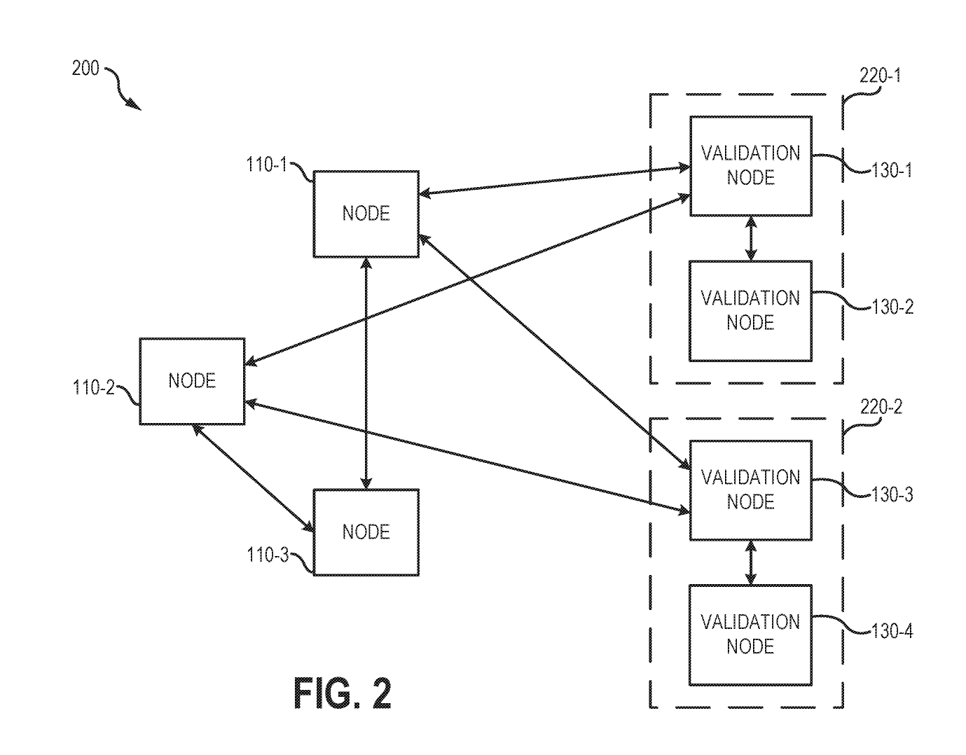

FIG. 2 is a block diagram illustrating a system for neural network consensus using blockchain and comprising multiple validation networks, in accordance with various embodiments; and

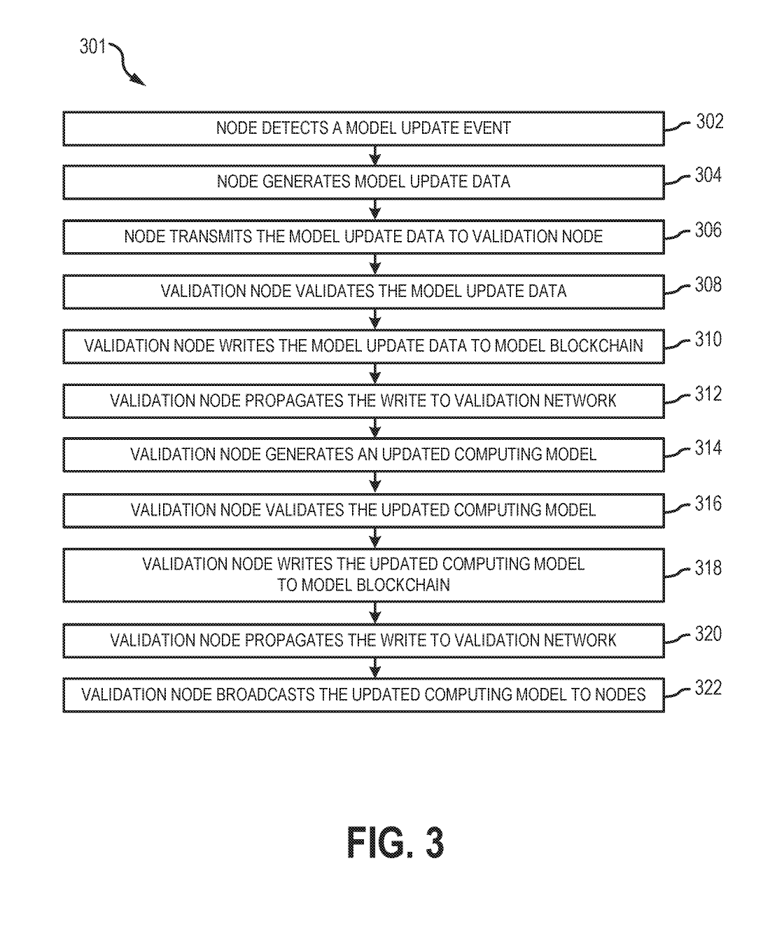

FIG. 3 illustrates a process flow for a method of updating computing models in a neural network, in accordance with various embodiments.

### DETAILED DESCRIPTION

The detailed description of various embodiments refers to the accompanying drawings, which show various embodiments by way of illustration. While these various embodiments are described in sufficient detail to enable those skilled in the art to practice the disclosure, it should be understood that other embodiments may be realized and that logical and physical changes may be made without departing from the spirit and scope of the disclosure. Thus, the detailed description is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The systems, methods, and computer readable mediums (collectively, the “system”) described herein provide neural network consensus and updates using blockchain technologies. In various embodiments, artificial neural networks (“ANN”) discussed herein may be used to perform various machine learning and artificial intelligence operations, tasks, and processing. ANNs may be used for various tasks and in a variety of industries. For example, ANNs may be used in industries such as, for example. healthcare, manufacturing, retail, surveillance, transportation, and the like. As a further example, ANNs may be used in vehicles (e.g., airplanes, automobiles, boats, transportation trucks, trains, etc.), drones, cameras, computers, data centers, data gathering devices, medical devices, point-of-sale registers, registration set-ups, robots, surveillance applications, and the like.

An ANN may comprise a plurality of computing nodes configured to individually and/or collective perform processing. Each local node may comprise a computing model configured to control processing in the local node. The computing model may not just be programmed to perform specific tasks, but rather may be programmed to learn to perform specific tasks. For example, rather than following task-specific rules, computing models may be programmed to review programmed exemplary datasets and draw non-programmed inferences from such datasets. In various embodiments, the computing model may generally learn through two processes involved in machine learning: training and inference. For example, computing models may learn during training by examining massive datasets, and using that learning from the training, the computing models may apply and/or draw predictive inferences based on new, non-programmed datasets. As a result, outputs from computing models may comprise non-linear averages of, and/or summations from, their inputs, enabling the computing nodes to process unsupervised (e.g., non-programmed) learning through pattern recognitions and/or the like. In various embodiments, computing models may therefore be adaptive models that change their dynamic structures based on internal and external dataflows through the ANN.

In various embodiments, each computing node in the ANN may initially be loaded with an initial computing model. As each node operates over time, model update events (e.g., prediction errors, new model requirements, etc.) may be observed. Each node may update the computing model locally based on the new processed data and discovered model update event. This provides an ability to optimize the ANN for local conditions. For example, in response to the computing model being used for image recognition of cars, the local backgrounds and local distribution of car types will vary. Local adaption therefore may improve the performance of the computing model. As local copies of the computing model diverge from the initially distributed computing model, it may be desired to update the original computing model for distribution to the other computing nodes (e.g., backpropagation). In various embodiments, the system may integrate blockchain technologies to facilitate updating computing models.

Blockchain technology provides a strong cryptographic mechanism to record the order of transactions and develop a consensus on characteristics of the transactions between distributed systems. A blockchain can be used to record and provide accepted computing models and/or model updates to distributed applications of the computing model. The use of this shared and secure record of computing models ensures that any of the distributed applications may easily validate the received model. Inclusion of a computing model on the blockchain provides a cryptographically strong proof that the computing model was validated by trusted nodes. In various embodiments, validation may be performed by having nodes check and/or test the proposed model (or differences to a computing model). In various embodiments, not all nodes in the ANN need to participate in the validation. The nodes participating in the validation accept or reject the new computing model (e.g., full model, difference set, etc.). The proposed model would consist of a combination of the received updates from peer validation nodes.

In various embodiments, use of the blockchain may also facilitate model updating payment transactions. For example, a requester (e.g., a model producing company) may offer payments or other incentives to one or more updating clients willing to share localized updated computing models. The blockchain may be used to create an immutable record of transactions between the parties. For example, the system may write to the blockchain a request transaction from the requester to an updating client, a response transaction (e.g., the updated computing model) from the updating client to the requester, and/or a payment transaction rom the requester to the updating client. Transaction workflows and payments may be based on one or more smart contracts deployed in the system. In that respect, an auditor or similar third party may parse and review transactions on the blockchain to verify that the updated computing model was transmitted from the updating to the requester, and that payment was transmitted back from the requester to the updating client.

The interaction and connectivity between distributed neural nodes in the system may not need to be a star configuration (e.g., cloud server with star topology to local/edge processing). Nodes may interact directly between peers to validate and create blockchain entries. Applications of a model may then use the blockchain and associated metadata to validate the model. The metadata included in each block written to the blockchain may include arbitrary data about the computing model, usage and characteristics of the model, a list of differences to the model, IP addresses or identifying data from the computing node initiating the update, and/or any other suitable data.

In various embodiments, computing model updates and divergences may not all come from the same location or computing node. Merging of updates to a computing model may be based on the input from multiple distributed observations. The updates may be shared as training data or as differences to the computing model based on problematic or new data. One or more processing nodes may receive the updates in different orders. In response to the system receiving multiple computing model updates, the processing may be ordered in a canonical manner to ensure that all of the distributed nodes calculate the same result.

In various embodiments, the system further improves the functioning of the computer-based system and/or artificial neural network. For example, by validating and updating computing models using blockchain, as opposed to needing a centralized server to separately validate and update the computing models, the system shares model updates more efficiently which speeds processing and decreases memory usage in computing node, and decreases the amount of data transferred over the ANN. Additionally, by transmitting, storing, and accessing data using the processes described herein, the security of the data is improved, which decreases the risk of the computer-based system, ANN, computing node, or computing model from being compromised. Further, by decentralizing system architecture and decentralizing the process of updating computing models, less infrastructure may be needed compared to typical systems and ANNs, and model updates may be shared across computing nodes in real time or near real time.

In various embodiments, the system may also provide a robust and secure method of updating models. In that regard, aspects of the system prevent a malicious actor or third party from inserting malicious code or incorrect models that may be detrimental to the overall operation of the models and/or system. In various embodiments, the system may also enable an “open” system wherein contributors are public, but communications are transmitted via encrypted channels and contributors are accountable for model updates and/or changes to the system. In that regard, the system may enable different entities lacking trust to share in trusted communications and to hold each other accountable.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data,” “datasets,” “information,” or the like may include encompassing information such as commands, queries, files, messages, data for storage, and the like in digital or any other form.

With reference to FIG. 1A, a system 100 for consensus and updating of neural network computing models using blockchain is depicted according to various embodiments. System 100 may include a neural network (e.g., an artificial neural network (ANN)) having various computing nodes implementing one or more computing models, as discussed further herein. The neural network implementing blockchain technologies, as described herein, may simplify and automate updating the computing models and related processes by using the blockchain as a distributed and tamper-proof data store.

In various embodiments, system 100 may comprise one or more computing nodes 110 (e.g., a first node 110-1, a second node 110-2, a third node 110-3, etc.) and one or more validation nodes 130 (e.g., a first validation node 130-1, a second validation node 130-2, etc.). Although the present disclosure makes reference to nodes 110-1, 110-2, and 110-3 and validation nodes 130-1 and 130-2, it should be understood that principles of the present disclosure may be applied to a system having any suitable number of interconnected computing nodes and/or validation nodes.

In various embodiments, nodes 110-1, 110-2, 110-3 and/or validation nodes 130-1, 130-2 may collectively form the neural network, with each node 110-1, 110-2, 110-3 and/or validation node 130-1, 130-2 configured to perform various artificial intelligence and machine learning operations using one or more computing models, as discussed further herein. Each node 110-1, 110-2, 110-3 may be in electronic and/or logical communication with one or more other nodes 110-1, 110-2, 110-3 and/or validation nodes 130-1, 130-2 via a network, such as a peer-to-peer network. For example, node 110-1 may be in electronic communication with node 110-3, validation node 130-1, and/or validation node 130-2; node 110-2 may be in electronic communication with node 110-3, validation node 130-1, and/or validation node 130-2; and/or node 110-3 may be in electronic communication with node 110-1 and/or node 110-2.

As used herein, the term “network” may further include any cloud, cloud computing system or electronic communications system or method that incorporates hardware and/or software components. Communication amongst the nodes may be accomplished through any suitable communication channels, such as, for example, a telephone network, an extranet, an intranet, Internet, point of interaction device (personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, AppleTalk, IP-6, NetBIOS, OSI, any tunneling protocol (e.g., IPsec, SSH, etc.), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems. Asymmetric encryption in particular may be of use in signing and verifying signatures for blockchain crypto operations.

For the sake of brevity, conventional data networking, application development, and other functional aspects of system 100 may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, nodes 110-1, 110-2, 110-3 and/or validation nodes 130-1, 130-2 may be loaded with one or more computing models, as discussed further herein. Each computing model may be configured to perform various processing, machine learning, and/or artificial intelligence operations. Each computing model may further comprise one or more sub-models configured to perform sub-tasks and operations.

In various embodiments, one or more nodes 110-1, 110-2, 110-3 may be a model requester (e.g., a model producing company, an entity desiring to purchase updated computing models, etc.). In that respect, one or more nodes 110-1, 110-2, 110-3 may be configured to write a request transaction to model blockchain 140. The request transaction may detail the desired model update (e.g., based on a model ID, model identifying data, update type, etc.), a payment amount, or the like. In various embodiments, one or more validation nodes 130-1, 130-2 may be a model updating client (e.g., an entity desiring to provide updated computing models, etc.). In that respect, one or more validation nodes 130-1, 130-2 may be configured to retrieve the request transaction from model blockchain 140, and write a response transaction to model blockchain 140 based on the request transaction. For example, the respective validation node 130-1, 130-2 may write model updating data, an update computing model, or the like to blockchain 140, as discussed further herein. The respective node 110-1, 110-2, 110-3 may retrieve the response transaction from model blockchain 140, and may transmit a payment transaction to the corresponding validation node 130-1, 130-2 to complete the model updating payment transaction. In various embodiments, one or more nodes 110-1, 110-2, 110-3 and/or validation nodes 130-1, 130-2 may be an auditing party configured to monitor and review blockchain 140 to ensure that the model updating payment transaction was completed. The auditing party may be a third party system separate from system 100.

In various embodiments, validation nodes 130-1, 130-2 may be part of a validation network 120. Validation network 120 may be a blockchain network or peer-to-peer network that is private, consortium and/or public in nature (e.g., ETHEREUM®, HYPERLEDGER® Fabric, etc.). Consortium and private networks may offer improved control over the content of the blockchain and public networks may leverage the cumulative computing power of the network to improve security. Validation network 120 may comprise any suitable number of validation nodes 130, and each validation node 130 may be in electronic communication with one or more other validation nodes 130. In that respect, each validation node 130 may function as a blockchain node in the blockchain network. As discussed further herein, each validation node 130-1, 130-2 may maintain a copy (or partial copy) of one or more model (or sub-model) blockchains configured to store and maintain model update data. Validation nodes 130-1, 130-2 may communicate according to a gossip protocol, or the like, that defines communications amongst computers in the network, manages membership to the network, and controls the broadcast of messages across the network. For example, the gossip protocol may comprise a typical gossip protocol implemented by blockchain technologies.

In various embodiments, and with reference to FIG. 2, a system 200 may comprise a plurality of validation networks, with each validation network comprising (and/or sharing) one or more validation nodes. In that respect, each validation network may be configured to validate and update different computing models and/or computing sub-models. For example, system 200 may comprise a first validation network 220-1, a second validation network 220-2, and/or any suitable number of validation networks. As a further example, first validation network 220-1 may comprise a first validation node 130-1, a second validation node 130-2, and/or any other suitable number of validation nodes. In that regard, validation nodes 130-1, 130-2 may be configured to store and maintain a first model blockchain corresponding to model updates of a first model (or sub-model). As a further example, second validation network 220-2 may comprise a third validation node 130-3, a fourth validation node 130-4, and/or any other suitable number of validation nodes. In that regard, validation nodes 130-3, 130-4 may be configured to store and maintain a second model blockchain corresponding to model updates of a second model (or sub-model).

In various embodiments, and with reference again to FIG. 1A, each node 110-1, 110-2, 110-3 and/or validation node 130-1, 130-2 may comprise one or more computing devices, such as, for example a computer or processor, or a set of computers, processor, and/or application specific integrated circuits (ASICs), although other types of computing units or system may also be used. Exemplary computing devices may include servers, pooled servers, laptops, notebooks, hand held computers, smart phones (e.g., IPHONE®, BLACKBERRY®, ANDROID®, etc.), tablets, Internet of things (IoT) devices, or any other device capable of receiving data over a network. Each node 110-1, 110-2, 110-3 and/or validation node 130-1, 130-2 may include one or more processors and/or one or more tangible, non-transitory memories and be capable of implementing logic. Each processor may be configured to implement various logical operations in response to execution of instructions, for example, instructions stored on a non-transitory, tangible, computer-readable medium, as discussed further herein.

In various embodiments, and with reference to FIG. 1B, an exemplary computing node 110 is depicted (e.g., node 110-1, 110-2, and/or 110-3). Node 110 may comprise any suitable combination of hardware, software, and/or database or memory components. For example, node 110 may comprise a processor 112, a memory 114, and/or a communication interface 116.

Memory 114 may comprise any suitable database, data structure, memory component, or the like capable of storing data. For example, memory 114 may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like. Memory 114 may store, for example, data as instructed by processor 112, instructions usable by processor 112 to perform operations as described herein, or the like. Memory 114 may also be configured to store and maintain one or more computing models.

Communication interface 116 may comprise one or more hardware and/or software components capable of communicating with one or more other nodes in the neural network. For example, communication interface 116 may be configured to communicate via any wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZigBee® protocol maintained by the ZigBee alliance), a cellular protocol, an infrared protocol, an optical protocol, or any other protocol capable of transmitting information via a wired or wireless connection. Communication interface 116 may be configured to transmit and receive model update data to one or more validation nodes 130, as discussed further herein.

Processor 112 may include any logic device such as one or more of a central processing unit (CPU), an accelerated processing unit (APU), a digital signal processor (DSP), a field programmable gate array (FPGA), an application specific integrated circuit (ASIC), or the like. Processor 112 may be configured to provide instructions to memory 114 and communication interface 116. For example, and as discussed further herein, processor 112 may be configured to retrieve one or more computing models from memory 114, and perform various artificial intelligence and machine learning operations based on instructions contained therein. In various embodiments, in response to detecting a model update event while using a computing model, processor 112 may be configured to generate model update data, as discussed further herein. The model update data may comprise training data (e.g., data to be ingested by a node to “train” the computing model to cure the prediction error, detect the new model requirement, etc.) and/or a model update (e.g., programmable code to merge with the computing model to cure the prediction error, detect the new model requirement, etc.). For example, the training data may comprise metadata including a description, an image, detail of the new object, or the like. Processor 112 may also be configured to perform various crypto-operations, such as, for example, digitally signing and/or encrypting data transmission, decrypting received data transmissions, and/or the like.

In various embodiments, and with reference to FIG. 1C, an exemplary validation node 130 is depicted (e.g., validation node 130-1 and/or 130-2). Validation node 130 may comprise any suitable combination of hardware, software, and/or database or memory components. For example, validation node 130 may comprise a processor 132, a memory 134, a communication interface 136, and/or a local model blockchain 140.

Memory 134 may comprise any suitable database, data structure, memory component, or the like capable of storing data. For example, memory 134 may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like. Memory 134 may store, for example, data as instructed by processor 132, instructions usable by processor 132 to perform operations as described herein, or the like. Memory 134 may be configured to store and maintain computing models and/or copies of model blockchain 140, as discussed further herein.

Communication interface 136 may comprise one or more hardware and/or software components capable of communicating with one or more other nodes in the neural network. For example, communication interface 136 may be configured to communicate via any wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZigBee® protocol maintained by the ZigBee alliance), a cellular protocol, an infrared protocol, an optical protocol, or any other protocol capable of transmitting information via a wired or wireless connection.

Processor 132 may include any logic device such as one or more of a central processing unit (CPU), an accelerated processing unit (APU), a digital signal processor (DSP), a field programmable gate array (FPGA), an application specific integrated circuit (ASIC), or the like. Processor 132 may be configured to provide instructions to memory 134 and communication interface 136. For example, and as discussed further herein, processor 132 may be configured to retrieve one or more computing models from memory 134, and perform various artificial intelligence and machine learning operations based on instructions contained therein. In various embodiments, processor 132 may also be configured to receive model update data from one or more nodes 110, generate updated computing models, and interact with model blockchain 140, as discussed further herein.

In response to receiving the model update data, processor 132 may interact with model blockchain 140 to write the model update data, write an updated computing model, and/or the like, as discussed further herein. For example, processor 132 may run applications, application programming interfaces (APIs), software development kits (SDKs), blockchain oracles, or the like to interact with model blockchain 140, communicate with other nodes, perform crypto-operations, consent with other nodes to writes on model blockchain 140, and otherwise operate within system 100. For example, processor 132 may run a client application that can be a thin client (web), a hybrid (i.e., web and native, such as iOS and Android), or a native application to make application programming interface (API) calls to interact with model blockchain 140, such as a web3 API compatible with blockchain databases maintained by ETHEREUM®. In various embodiments, processor 132 may also be configured to perform various crypto-operations, such as, for example, digitally signing and/or encrypting data transmission, decrypting received data transmissions, and/or the like.

In various embodiments, model blockchain 140 may be a distributed ledger that maintains records in a readable manner and that is resistant to tampering. In various embodiments, model blockchain 140 may be stored in memory 134 and/or as a separate data structure. Model blockchain 140 may comprise a ledger of interconnected blocks containing data. Each block may link to the previous block and may include a timestamp. Each block may hold one or more of model update data, updated models, initially deployed computing models, or the like. When implemented in support of system 100, model blockchain 140 may serve as an immutable log of model updates, and/or model updating payment transactions, in system 100. Model blockchain 140 may be maintained on various validation nodes (e.g., validation node 130-1, validation node 130-2, etc.) in the form of copies or partial copies of the model blockchain, as discussed further herein. Blocks (e.g., model update data, updated models, initially deployed computing models, etc.) may be written to model blockchain 140 by establishing consensus between the blockchain nodes based on proof of work, proof of stake, practical byzantine fault tolerance, delegated proof of stake, or other suitable consensus algorithms. For example, consensus may also be established using a hashgraph algorithm, delegated proof of stake (DPoS), delegated asynchronous proof of stake (DAPoS), or the like. In various embodiments, model blockchain 140 may comprise any suitable blockchain technology or platform discussed herein. In various embodiments, model blockchain 140 may also be built on any other suitable distributed ledger technology, such as, for example, hashgraph, delegated proof of stake (DPoS), delegated asynchronous proof of stake (DAPoS), or the like.

In various embodiments, model blockchain 140 may implement smart contracts, and/or similar blockchain technologies, that enforce data workflows in a decentralized manner. For example, validation and/or acceptance of a new model, model update, or the like, may be controlled by smart contracts. As a further example, the interrelationships, communications, and data broadcasts between nodes 110-1, 110-2, 110-3 and/or validation nodes 130-1, 130-2 may be controlled by smart contracts. The smart contracts may use the initial computing models, new models, and/or model updates to determine actions to perform in system 100. In various embodiments, the smart contracts may enforce workflows and transaction for model updating payment transactions, as discussed further herein. The smart contracts may include a program written in a programming language such as, for example, Solidity, or any other suitable programming language.

In various embodiments, each node 110-1, 110-2, 110-3, and/or validation node 130-1, 130-2 may each be assigned cryptographic keys (e.g., asymmetric keys) used to digitally sign and/or encrypt transmissions in system 100. In various embodiments, the asymmetric keys may be certificate-based, and issuance of the certificates may be controlled by an external or internal trust authority. For example, each node 110-1, 110-2, 110-3, and/or validation node 130-1, 130-2 may register with system 100 and/or an existing trust participant (e.g., identity provider, such as, for example a trusted certificate authority like VeriSign®, DigiCert®, etc.), and may be assigned and provided a private key and public key pair. System 100 may also generate the public key and private key pair using any suitable key pair generation technique and asymmetric key algorithm. In various embodiments, system 100 may use a Hierarchical Deterministic (HD) solution to enable the creation of one or more child keys from one or more parents keys in a hierarchy. Each child key may be assigned to an individual node 110-1, 110-2, 110-3, and/or validation node 130-1, 130-2. For example, system 100 may use BIP32, BIP39, and/or BIP44 to generate an HD tree of public addresses. In various embodiments, each node 110-1, 110-2, 110-3, and/or validation node 130-1, 130-2 may also be configured to generate a private key and public key pair individually. In that respect, the public key may be shared via the peer-to-peer network to each node 110-1, 110-2, 110-3, and/or validation node 130-1, 130-2.

For example, each node 110-1, 110-2, 110-3 may use its associated public key to digitally sign transactions (e.g., transmissions of model update data) in system 100. Each node 110-1, 110-2, 110-3, and/or validation node 130-1, 130-2 may also be configured to verify digital signatures, maintain integrity of Merkle tree, verify proof of work, and/or the like, similar to typical blockchain technologies. Consensus may be reached on writes to model blockchain 140 using any suitable or desired consensus method or algorithm, such as, for example, proof of work, proof of stake, practical byzantine fault tolerance, delegated proof of stake, or any other suitable consensus algorithm. In various embodiments, each validation node 130-1,130-2 may also need consensus from all validation nodes 130-1,130-2 connected in in validation network 120 before consenting to the write.

Referring now to FIG. 3, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps depicted in FIG. 3, but also to the various system components as described above with reference to FIGS. 1A-1C and 2.

With specific reference to FIG. 3, a method 301 for updating consensus of computing model updates in a neural network is disclosed. In various embodiments, nodes 110-1, 110-2, 110-3 may each be loaded with one or more computing models configured to perform various machine learning and artificial intelligence operations. In various embodiments, initial setup, installation, configuration, or the like of the computing models may vary and be completed using any suitable technique. For example, participation in the system may be limited based on a defined list of X.509 certificates (wherein certificates are generated for new nodes joining system 100), may be restricted based on a private network configuration, may be restricted based on issued blockchain addresses, or the like.

Node 110 detects a model update event (step 302). For example, node 110 may detect the model update event while operating the computing model, through a transmission (e.g., an update is transmitted to node 110), or the like. The model update event may comprise a prediction error, a new model requirement, a customization event, or the like. For example, the prediction error may relate to an incorrect identification using the computing model, or may be associated with any other suitable or desired error. The new model requirement may relate to a new identification needed for the computing model. For example, wherein the computing model is configured to recognize inventory in a store, the new model requirement may be in response to a new good (e.g., soda, etc.) being offered as inventory in the store. Node 110 generates model update data (step 304) based on the model update event. The model update data may comprise training data (e.g., data to be ingested by a node to “train” the computing model to cure the prediction error, detect the new model requirement, etc.), a model update (e.g., programmable code to merge with the computing model to cure the prediction error, detect the new model requirement, etc.), and/or a new computing model.

Node 110 transmits the model update data to validation node 130 (step 306). In various embodiments, validation node 130 may transmit the model update data based on a distribution algorithm or the like. For example, and in accordance with various embodiments, delegation to a limited number of validation nodes 130 may be controlled or established via a delegated proof of stake system (DPoS). As a further example, delegation may be controlled by a smart contract (e.g., a publish and subscribe model) wherein validation and model updating is performed by one or more validation nodes 130. As a further example, delegation may be controlled by signed authorizations used to establish relationships between the nodes. In various embodiments, delegation to validation nodes 130 may also be static and defined, wherein each node 110 may comprise instructions detailing one or more validation nodes 130 to transmit the model update data to. In various embodiments, one or more validation nodes 130 may also publish contracts and offer a payment or the like to validate and/or update the model update data. Nodes 110 may select one or more validation nodes 130 based on the published contracts.

In various embodiments, in response to validation node 130 (and/or a plurality of validation nodes 130) receiving a plurality of model update data transmission simultaneously, in near time, or the like, the order of updating computing models may be based on a time stamp (e.g., time stamp present in the model update data, or a time stamp of when validation node 130 received the model update data). In various embodiments, the received plurality of model update data may also be aggregated and/or averaged together using an averaging model or algorithm. For more information regarding aggregation and averaging of model updates, see U.S. patent application Ser. No. ______, filed July X, 2018, entitled “SECURE FEDERATED NEURAL NETWORKS,” which is incorporated herein by reference in its entirety.

In response to receiving the model update data, validation node 130 validates the model update data (step 308). Validation node 130 may broadcast the model update data to one or more other validation nodes 130 in validation network 120. Validation nodes 130 may establish consensus to the model update data using any suitable or desired consensus method or algorithm, such as, for example, proof of work, proof of stake, practical byzantine fault tolerance, delegated proof of stake, or any other suitable consensus algorithm. Validation nodes 130 may also be configured to validate the model update data by locally testing the model update data to determine whether the model update data cures the prediction error, detects the new model requirement, or the like. For example, validation nodes 130 may locally implement the test data and/or model update, and may process data using the computing model to determine whether the prediction error is still an issue, whether the new model requirement can be detected, or the like. As a further example, validation nodes 130 may test the model update data to identity false positives, false negatives, or the like. Testing may also be performed by a human to identify new scenarios and/or to validate the model update data.

Validation node 130 writes the model update data to model blockchain 140 (step 310). Validation node 130 may be configured to write the model update data to model blockchain 140 together with any other suitable data, such as, for example a hash of the model update data, a date or timestamp, identifying information of the node 110 that transmitted the model update data (e.g., IP address, blockchain address, etc.), and/or any other suitable data or metadata. Validation node 130 propagates the write to validation network 120 (step 312). For example, validation node 130 may broadcast the write data (e.g., data associated with the block written to model blockchain 140, the model update data, etc.) to one or more validation nodes 130 in validation network 120. Each validation node 130 may be configured to write the model update data to its associated local model blockchain 140.

In various embodiments, validation node 130 generates an updated computing model (step 314) based on the model update data. For example, validation node 130 may be configured to generate the update computing model by merging the preexisting computing model with the model update data. For example, the preexisting computing model may be recomputed or retrained using the new training data, or parameters of the preexisting computing model may be changed based on the model update data.

Validation node 130 validates the updated computing model (step 316). Validation node 130 may broadcast the updated computing model to one or more other validation nodes 130 in validation network 120. Validation nodes 130 may establish consensus to the updated computing model using any suitable or desired consensus method or algorithm, such as, for example, proof of work, proof of stake, practical byzantine fault tolerance, delegated proof of stake, or any other suitable consensus algorithm. Validation nodes 130 may also be configured to validate the updated computing model by locally testing the updated computing model to determine whether the updated computing model cures the prediction error, detects the new model requirement, or the like. For example, validation nodes 130 may locally implement the updated computing model, and may process data using the computing model to determine whether the prediction error still results, to detect detects the new model requirement, or the like.

Validation node 130 writes the updated computing model to model blockchain 140 (step 318). Validation node 130 may be configured to write the updated computing model to model blockchain 140 together with any other suitable data, such as, for example a hash of the updated computing model, a date or timestamp, identifying information of the node 110 that transmitted the model update data (e.g., IP address, blockchain address, etc.), and/or any other suitable data or metadata.

Validation node 130 propagates the write to validation network 120 (step 320). For example, validation node 130 may broadcast the write data (e.g., data associated with the block written to model blockchain 140, the updated computing model, etc.) to one or more validation nodes 130 in validation network 120. Each validation node 130 may be configured to write the updating computing model to its associated local model blockchain 140.

Validation node 130 broadcasts the updated computing model to node 110 (step 322). In various embodiments, validation node 130 may broadcast the validated model update data to one or more nodes 110, instead of the updated computing model. In various embodiments, validation node 130 may broadcast the updated computing model based on a distribution algorithm or the like, as previously discussed herein.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with,” or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate,” “verify,” “audit,” or similar terms may include an exact authentication, verification, or audit; a partial authentication, verification, or audit; authenticating, verifying, or auditing a subset of data; a correspondence; satisfying certain criteria; an association; an algorithmic relationship; and/or the like.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. As those skilled in the art will appreciate, computer, nodes, or the like may include an operating system (e.g., WINDOWS®, UNIX®, LINUX®, SOLARIS®, MacOS®, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, and in accordance with various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory or in-memory (non-spinning) hard drives. The secondary memory may include, for example, a hard disk drive and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data files transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEBSPHERE®, WEBLOGIC®, JBOSS®, EDB® POSTGRES PLUS ADVANCED SERVER® (PPAS), etc.). In various embodiments, the server may include web servers (e.g. APACHE®, IIS, GWS, SUN JAVA® SYSTEM WEB SERVER, JAVA® Virtual Machine running on LINUX® or WINDOWS®).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

As those skilled in the art will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, UNIX® OS, LINUX® OS, SOLARIS®, MacOS®, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

Any databases discussed herein may include relational, hierarchical, graphical, blockchain, or object-oriented structure and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MySQL by MySQL AB (Uppsala, Sweden), MONGODB®, REDIS®, APACHE CASSANDRA®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPE”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE® MQ™ (formerly MQSeries) by IBM®, Inc. (Armonk, N.Y.) is an example of a commercially available middleware product. An Enterprise Service Bus (“ESB”) application is another example of middleware.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, MACROMEDIA® Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript or the like. Cryptography and network security methods are well known in the art, and are covered in many standard texts.

In various embodiments, the software elements of the system may also be implemented using Node.js®. Node.js® may implement several modules to handle various core functionalities. For example, a package management module, such as Npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY, optical storage devices, magnetic storage devices, and/or the like.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIG. 3, the process flows and screenshots depicted are merely embodiments and are not intended to limit the scope of the disclosure. For example, the steps recited in any of the method or process descriptions may be executed in any order and are not limited to the order presented.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims.

Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, by a validation node, model update data corresponding to a computing model distributed in a neural network;
validating, by the validation node, the model update data by establishing consensus with at least a second validation node;
writing, by the validation node, the model update data to a model blockchain;
generating, by the validation node, an updated computing model based on the model update data; and
broadcasting, by the validation node, the updated computing model to a first node in the neural network.

2. The method of claim 1, further comprising:
validating, by the validation node, the updated computing model by at least one of establishing consensus with at least the second validation node or testing the updated computing model; and
writing, by the validation node, the updated computing model to the model blockchain.

3. The method of claim 2, further comprising propagating, by the validation node, the updated computing model write to the model blockchain to at least the second validation node in the neural network.

4. The method of claim 1, further comprising propagating, by the validation node, the model update data write to the model blockchain to at least the second validation node.

5. The method of claim 1, wherein the model update data comprises at least one of testing data or an updated model.

6. The method of claim 1, wherein the model update data is generated by the first node of the neural network based on the detection of a model update event in the computing model.

7. The method of claim 6, wherein the model update event comprises at least one of a prediction error or a new model requirement.

8. The method of claim 1, wherein consensus is established using a hashgraph algorithm, delegated proof of stake (DPoS), or delegated asynchronous proof of stake (DAPoS).

9. A neural network, comprising:
a first node comprising a computing model and a node processor configured to execute the computing model; and
a first validation node comprising:
a processor;
a model blockchain; and
a tangible, non-transitory memory configured to communicate with the processor, the tangible, non-transitory memory having instructions stored thereon that, in response to execution by the processor, cause the processor to perform operations comprising:
receiving, by the processor, model update data from the first node, wherein the model update data corresponds to the computing model;
validating, by the processor, the model update data by establishing consensus with at least a second validation node in the neural network;
writing, by the processor, the model update data to the model blockchain;
generating, by the processor, an updated computing model based on the model update data; and
broadcasting, by the processor, the updated computing model to the first node.

10. The neural network of claim 9, further comprising:
validating, by the processor, the updated computing model by at least one of establishing consensus with at least the second validation node in the neural network or testing the updated computing model; and
writing, by the processor, the updated computing model to the model blockchain.

11. The neural network of claim 10, further comprising propagating, by the processor, the updated computing model write to the model blockchain to at least the second validation node in the neural network.

12. The neural network of claim 10, further comprising propagating, by the processor, the model update data write to the model blockchain to at least the second validation node in the neural network.

13. The neural network of claim 10, wherein the model update data comprises at least one of testing data or an updated model.

14. The neural network of claim 10, wherein the model update data is generated by the first node based on the detection of a model update event in the computing model, and wherein the model update event comprises at least one of a prediction error or a new model requirement.

15. A method for updating computing models in an artificial neural network (“ANN”), comprising:
detecting, by a first node of the ANN, a model update event while executing a computing model;
transmitting, by the first node of the ANN, model update data to a first validation node of the ANN, wherein the model update data is generated based on the model update event;
writing, by the first validation node of the ANN, the model update data to a model blockchain;
generating, by the first validation node of the ANN, an updated computing model based on the model update data;
writing, by the first validation node of the ANN, the updated computing model to the model blockchain; and
broadcasting, by the first validation node of the ANN, the updated computing model to the first node of the ANN.

16. The method of claim 15, further comprising validating, by the first validation node of the ANN, the model update data by establishing consensus with at least a second validation node in the ANN or testing the model update data.

17. The method of claim 15, wherein the model update event comprises at least one of a prediction error or a new model requirement.

18. The method of claim 15, further comprising validating, by the first validation node of the ANN, the updated computing model by at least one of establishing consensus with at least a second validation node in the ANN or testing the updated computing model.

19. The method of claim 15, further comprising propagating, by the first validation node of the ANN, at least one of the model update write to the blockchain or the updated computing model write to the blockchain to at least a second validation node in the ANN.

20. The method of claim 15, wherein the model update data comprises at least one of testing data or an updated model.
